(19) United States
(12) Patent Application Publication
(10) Pub. No.: US 2017/0066169 A1
(43) Pub. Date: Mar. 9, 2017

(54) MOBILE PHONE CASE AND INJECTION MOLD FOR THE SAME

(71) Applicant: SAMSUNG ELECTRONICS CO., LTD., Suwon-si (KR)

(72) Inventors: Young Min KIM, Suwon-si (KR); Dong Hee LEE, Suwon-si (KR); Jeong-A KANG, Seongnam-si (KR); Min Hyouk KIM, Seongnam-si (KR); Jae Jin SEOK, Suwon-si (KR); Min Yeong JEONG, Seoul (KR); Sun Gil KIM, Suwon-si (KR); Jun Hyeok KYOUNG, Uiwang-si (KR); Su Hyun LEE, Uiwang-si (KR)

(73) Assignee: SAMSUNG ELECTRONICS CO., LTD., Suwon-si (KR)

(21) Appl. No.: 15/259,186

(22) Filed: Sep. 8, 2016

(30) Foreign Application Priority Data
Sep. 8, 2015 (KR) 10-2015-0126968

(51) Int. Cl. B29C 45/30; B29C 45/27; B29C 45/73; B29C 45/16

(52) U.S. Cl. CPC B29C 45/30; B29C 45/16; B29C 45/2701; B29C 45/73; B29C 2045/1698; B29C 2045/308; B29K 2069/00

(57) ABSTRACT

A mobile phone case injection mold includes a first molding plate and a second molding plate to form a cavity corresponding to a mobile phone case to be manufactured, a first injection device to inject a first molten resin, a second injection device to inject a second molten resin, a first runner to guide the first molten resin, a second runner to guide the second molten resin and a mixing runner to simultaneously guide the first and second molten resins to mix the first and second molten resins, thereby producing a mobile phone case having a pattern formed by mixing the first and second molten resins.

### CROSS-REFERENCE TO RELATED APPLICATIONS

This application claims the benefit of Korean Patent Application No. 10-2015-0126968, filed on Sep. 8, 2015 in the Korean Intellectual Property Office, the disclosure of which is incorporated herein by reference.

### BACKGROUND

1. Field

Embodiments of the present disclosure relate to a mobile phone case and a mobile phone case injection mold to manufacture the mobile phone case.

2. Description of the Related Art

A mobile phone case is usually used as a case for the rear surface of the mobile phone and is generally manufactured by injecting a molten resin into a cavity of a mobile phone case injection mold, and curing the resin.

Mobile phone cases are manufactured using a single type of resin to obtain uniform strength throughout the entire structures. If a mobile phone case is manufactured using a single type of resin, a pattern may be formed on the external surface of the mobile phone case by coating, painting, or the like.

However, the pattern formed on the external surface of the mobile phone case by coating or painting may be damaged or scraped by friction or impact caused while being used.

### SUMMARY

Therefore, it is an aspect of the present disclosure to provide a mobile phone case having a pattern that is not easily damaged, and a mobile phone case injection mold to manufacture the same.

Additional aspects of the disclosure will be set forth in part in the description which follows and, in part, will be apparent from the description, or may be learned by practice of the disclosure.

In accordance with one aspect of the present disclosure provides a mobile phone case injection mold including a first molding plate, a second molding plate to form a cavity corresponding to a mobile phone case to be manufactured together with the first molding plate, a first injection device to inject a first molten resin, a second injection device to inject a second molten resin formed of the same material as the first molten resin and having a different color, a first runner to guide the first molten resin, a second runner to guide the second molten resin, and a mixing runner to simultaneously guide the first and second molten resins to mix the first and second molten resins.

The mobile phone case injection mold may further include a manifold at which the first runner, the second runner, and the mixing runner are disposed.

The manifold may include a first member and a second member disposed at upper and lower sides and coupled to each other, and the first runner, the second runner, and the mixing runner are disposed between the first member and the second member.

The mobile phone case injection mold may further include a heater disposed in the manifold.

The first runner and the second runner may be arranged symmetrically at both sides of the mixing runner and join together at the mixing runner, and the injection mold may further comprise a guide part protruding toward the mixing runner, the guide part being disposed at a joining portion of the first runner and the second runner to guide molten resins.

The guide part may have a vertex arranged toward the mixing runner, a first surface disposed at one side of the vertex and facing the first runner, and a second surface disposed at the other side of the vertex and facing the second runner.

The first runner may have a greater width than the second runner.

In accordance with another aspect of the present disclosure, a mobile phone case is manufactured by mixing a first molten resin with a second molten resin formed of the same material as the first molten resin and having a different color from the first molten resin and curing a mixture of the first and second molten resins.

The mobile phone case may have an irregular pattern formed while the first and second molten resins are mixed.

The first molten resin may be injected in a greater amount than the second molten resin to form a ground color of the mobile phone case, and the second molten resin is injected in a smaller amount than the first molten resin to form a pattern of the mobile phone case.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematic view of a mobile phone case injection mold according to an embodiment of the present disclosure;

FIG. 2 is a schematic view of the mobile phone case injection mold and a mobile phone case separated from the mobile phone case injection mold according to the embodiment of the present disclosure;

FIG. 3 is a schematic view of runners of the mobile phone case injection mold according to the embodiment of the present disclosure;

FIG. 4 is a real view of the mobile phone case manufactured by the mobile phone case injection mold according to the embodiment of the present disclosure;

FIG. 5 is a schematic view of runners of the mobile phone case injection mold according to another embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

Hereinafter, a mobile phone case injection mold to manufacture a mobile phone case according to an embodiment will be described in detail with reference to the accompanying drawings.

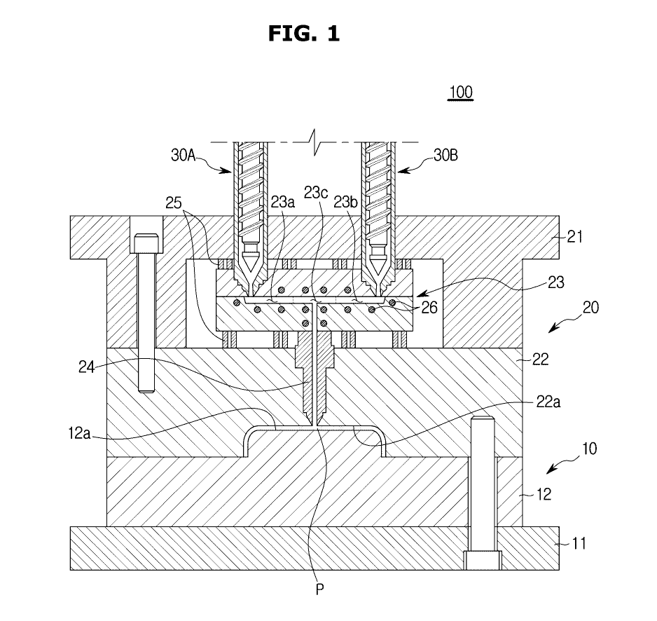

Referring to FIG. 1, a mobile phone case injection mold 100 includes a first mold 10 and a second mold 20 coupled to each other to form a cavity therebetween, which will be described later, and injection devices 30A and 30B to inject a molten resin into the cavity.

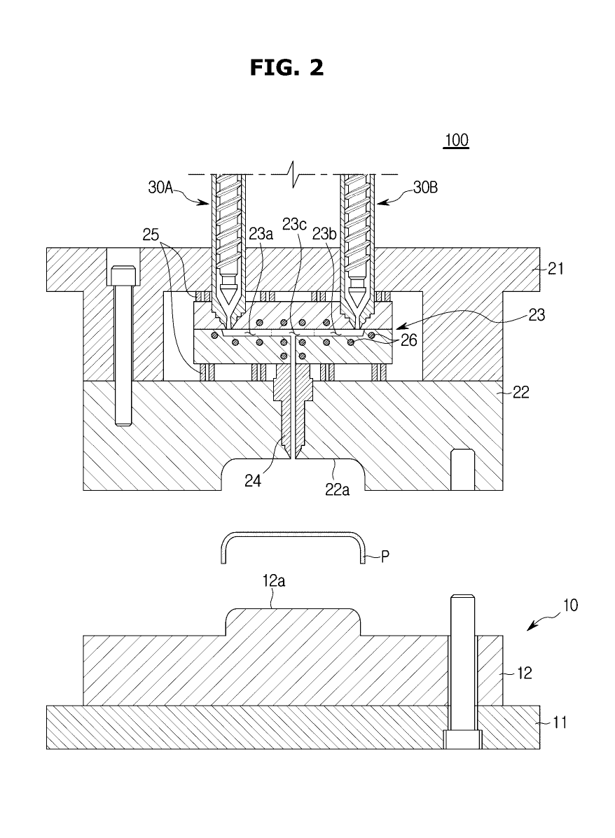

According to an embodiment, the first mold 10 is fixedly mounted on the ground, and the second mold 20 is vertically movably installed above the first mold 10. The first mold 10 and the second mold 20 are coupled to each other to form a cavity, which will be described later, in accordance with movement of the second mold 20. As illustrated in FIG. 2, the first mold 10 and the second mold 20 may be decoupled from each other to separate a mobile phone case P (FIG. 2) fabricated in the cavity.

The first mold 10 includes a first fixing plate 11 supported by the ground and a first molding plate 12 fixedly mounted on the first fixing plate 11 and having a first molding surface 12a with a shape corresponding to a first surface of the mobile phone case P to be fabricated.

The second mold 20 includes a second fixing plate 21 vertically movably installed and a second molding plate 22 fixedly mounted on the second fixing plate 21 and having a second molding surface 22a with a shape corresponding to a second surface of the mobile phone case P opposite to the first surface.

Thus, a cavity corresponding to a shape of the mobile phone case P to be fabricated is formed between the first molding surface 12a and the second molding surface 22a.

The injection devices 30A and 30B are installed at the second mold 20 located at an upper side and inject molten resins into the cavity downward. According to an embodiment, the injection devices 30A and 30B include a first injection device 30A to inject a first molten resin with a first color into the cavity and a second injection device 30B to inject a second molten resin with a second color different from the first color into the cavity. In this case, the first molten resin and the second molten resin are formed of the same material with different colors. According to an embodiment, both of the first molten resin and the second molten resin are formed of polycarbonate.

In addition, the second mold 20 includes a manifold 23 to mix the first molten resin from the first injection device 30A with the second molten resin from the second injection device 30B and a nozzle 24 to guide a mixture of the molten resins mixed in the manifold 23 to be injected into the cavity.

The manifold 23 is disposed in a space between the second fixing plate 21 and the second molding plate 22 to be spaced apart from the second fixing plate 21 and the second molding plate 22 by spacers 25.

In addition, the manifold 23 includes runners 23a, 23b, and 23c to guide and mix the first molten resin and the second molten resin from the first and second injection devices 30A and 30B.

Also, heaters 26 to generate heat are arranged in the manifold 23 such that the molten resins passing through the runners 23a, 23b, and 23c are maintained in molten states by maintaining the molten resins at a predetermined temperature or higher.

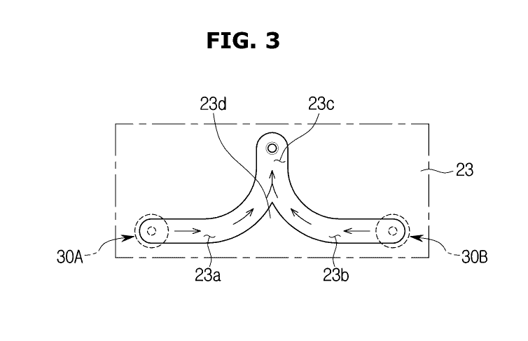

The runners 23a, 23b, and 23c include a first runner 23a to guide the first molten resin injected by the first injection device 30A, a second runner 23b to guide the second molten resin injected by the second injection device 30B, and a mixing runner 23c connected to the first runner 23a and the second runner 23b and simultaneously guiding the first molten resin from the first runner 23a and the second molten resin from the second runner 23b, as illustrated in FIG. 3. The first molten resin and the second molten resin are mixed while passing through the mixing runner 23c and injected into the cavity formed between the first molding surface 12a and the second molding surface 22a through the nozzle 24.

According to an embodiment, the first runner 23a and the second runner 23b, which are symmetrically arranged at both sides of the mixing runner 23c, join together at the mixing runner 23c. In this case, a guide part 23d protruding toward the mixing runner 23c is disposed at a joining portion of the first runner 23a and the second runner 23b to prevent the first molten resin flowing from the first runner 23a from flowing into the second runner 23b or prevent the second molten resin flowing from the second runner 23b from flowing into the first runner 23a.

The guide part 23d has a triangular shape in which one vertex is aligned toward the mixing runner 23c. A first surface of the guide part 23d disposed at one side of the vertex of the guide part 23d, arranged toward the mixing runner 23c, faces the first runner 23a and guides the first molten resin flowing from the first runner 23a into the mixing runner 23c. A second surface of the guide part 23d disposed at the other side of the vertex of the guide part 23c faces the second runner 23b and guides the second molten resin flowing from the second runner 23b into the mixing runner 23c. A length of a protruding portion of the guide part 23d is greater than widths of the first runner 23a and the second runner 23b to more completely inhibit backflows of the molten resins.

Thus, when the first and second molten resins are simultaneously injected via the first injection device 30A and the second injection device 30B, the first molten resin flowing from the first runner 23a and the second molten resin flowing from the second runner 23b are guided by the first and second surfaces of the guide part 23d to be transported to the mixing runner 23c, simultaneously. The first and second molten resins are mixed together while passing through the mixing runner 23c and injected into the cavity via the nozzle 24.

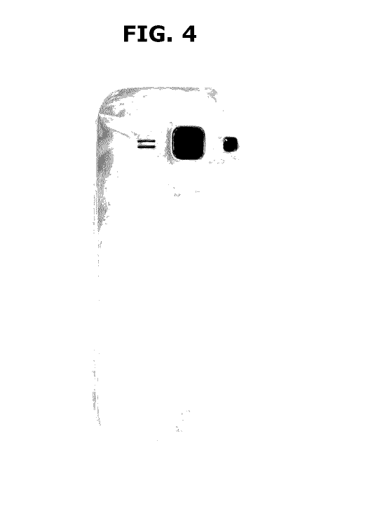

Since the first and second molten resins are formed of the same material with different colors as described above, a mixed resin of the first and second molten resins is injected into the cavity in an irregular pattern and cured in the cavity to form the mobile phone case P. Thus, the mobile phone case P fabricated by using the mobile phone case injection mold 100 according to an embodiment has an irregular pattern as shown in FIG. 4. Since the pattern of the fabricated mobile phone case P is formed by the resin constituting the mobile phone case P, the pattern is not easily damaged by friction or impact. Although the pattern is damaged, a damaged portion is not easily distinguishable from the pattern formed inside the mobile phone case P.

In addition, since the first and second molten resins are the same material as described above, the fabricated mobile phone case P may have a uniform strength throughout the entire structure.

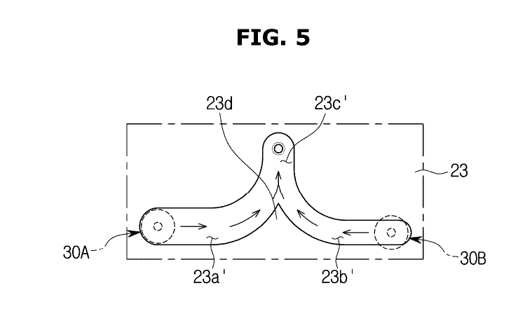

Although the first runner 23a and the second runner 23b have the same width according to the present embodiment, the widths thereof are not limited thereto. As illustrated in FIG. 5, the first runner 23a′ may have a relatively greater width than the second runner 23b′ coupled to the mixing runner 23c′ to inject a relatively greater amount of the first molten resin into the first runner 23a′ such that the first molten resin forms a ground color of the mobile phone case P and the second molten resin forms a color pattern of the mobile phone case P.

Although the runners 23a, 23b, and 23c are provided in the manifold 23 according to the present embodiment, the embodiment is not limited thereto. The runners 23a, 23b, and 23c may also be disposed at any component of the mobile phone case injection mold depending on the structure thereof.

Although two molten resins, i.e., the first and second molten resins, are mixed according to the present embodiment, the embodiment is not limited thereto. More than two molten resins may also be mixed to form a pattern of the mobile phone case. In this case, the molten resins need to be formed of the same material with different colors.

As is apparent from the above description, the mobile phone case according to an embodiment of the present disclosure has a pattern formed by mixing the first and second molten resins, which are the same material with different colors, and curing the mixture, the pattern is not easily damaged. Although the pattern is damaged, a damaged portion is not easily distinguishable from the pattern formed inside the mobile phone case P.

In addition, since the first and second molten resins are the same material, the mobile phone case may have a uniform strength throughout the entire structure.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A mobile phone case injection mold comprising:
a first molding plate;
a second molding plate to be coupled to the first molding plate to form a cavity between the first and second molding plates corresponding to a mobile phone case to be manufactured;
a first injection device disposed at the second molding plate to inject a first molten resin towards the cavity;
a second injection device disposed at the second molding plate to inject, towards the cavity, a second molten resin formed of approximately same material as the first molten resin and having a different color than a color of the first molten resin;
a first runner coupled to the first injection device to guide a flow of the first molten resin from the first injection device;
a second runner coupled to the second injection device to guide a flow the second molten resin from the second injection device; and
a mixing runner coupled to the first and second runners to simultaneously guide flows of the first and second molten resins from the first and second runners to cause mixing of the first and second molten resins while the injected first and second molten resins pass through the mixing runner and into the cavity to manufacture the mobile phone case.

2. The mobile phone case injection mold according to claim 1, further comprising a manifold at which the first runner, the second runner, and the mixing runner are disposed.

3. The mobile phone case injection mold according to claim 1, wherein the manifold comprises a first member and a second member disposed at upper and lower sides and coupled to each other, and
the first runner, the second runner, and the mixing runner are disposed between the first member and the second member.

4. The mobile phone case injection mold according to claim 2, further comprising a heater disposed in the manifold.

5. The mobile phone case injection mold according to claim 1, wherein the first runner and the second runner are arranged symmetrically at both sides of the mixing runner and joined together at the mixing runner, and
the injection mold further comprises a guide part protruding toward the mixing runner, the guide part being disposed at a joining portion of the first runner and the second runner to guide the flows of the first and second molten resins to be mixed and injected into the cavity for the manufacture the mobile phone case.

6. The mobile phone case injection mold according to claim 5, wherein the guide part has a vertex arranged toward the mixing runner, a first surface disposed at one side of the vertex and facing the first runner, and a second surface disposed at other side of the vertex and facing the second runner.

7. The mobile phone case injection mold according to claim 5, wherein the first runner has a greater width than the second runner.

8. A method of manufacturing a mobile phone case using an injection mold, the method comprising:
injecting, by a first injection device disposed in a movable molding plate, a first molten resin towards a cavity corresponding to the mobile phone case; and
injecting towards the cavity, by a second injection device disposed in the movable molding plate, a second molten resin formed of approximately same material as the first molten resin and having a different color than a color of the first molten resin,
the cavity formed between the movable molding plate and a fixed molding plate, and
the injecting causing mixing of flows of the first molten resin with the second molten resin from respective first and second runners coupled to the first and second injection devices and respectively coupled to a mixing runner, while the flows of the first and second molten resins pass through the mixing runner to manufacture the mobile phone case formed of the mixed first and second molten resins in the cavity.

9. A mobile phone case manufactured according to claim 8, wherein the mobile phone case has an irregular color pattern.

10. The mobile phone case according to claim 9, wherein the first molten resin is injected in a greater amount than the second molten resin to form a ground color of the mobile phone case, and
the second molten resin is injected in a smaller amount than the first molten resin to form a color pattern of the mobile phone case.
